(19) United States
(12) Patent Application Publication
(10) Pub. No.: US 2020/0057586 A1
(43) Pub. Date: Feb. 20, 2020

(54) COMPUTER SYSTEM AND DATA STORAGE METHOD

(71) Applicant: Hitachi, Ltd., Chiyoda-ku, Tokyo (JP)

(72) Inventors: Shinri INOUE, Tokyo (JP); Hisaharu TAKEUCHI, Tokyo (JP); Toshiya SEKI, Tokyo (JP)

(21) Appl. No.: 16/088,170

(22) PCT Filed: Jul. 27, 2016
(86) PCT No.: PCT/JP2016/071962

§ 371 Date: Sep. 25, 2018

(51) Int. Cl. G06F 3/06

(52) U.S. Cl. CPC G06F 3/0665; G06F 3/0673; G06F 3/0644; G06F 3/0647; G06F 3/0614

(57) ABSTRACT

After a first write request, when a third write request for requesting to write, in a first logical area, second data not stored in a data storage area, a processor calculates second identification information based on the second data, writes the second data in a second physical area in the data storage area, registers, in conversion information, association of an address of the first logical area, an address of the second physical area, first present identification information indicating the second identification information, and first old identification information indicating first identification information, and registers, in duplication information, association of the second identification information and the address of the first logical area. When the first logical area satisfies a preset separation condition, the processor deletes the address of the first logical area from the duplication information and deletes the first old identification information from the information associated with the address of the first logical area in the conversion information.

### TECHNICAL FIELD

The present invention relates to a computer system.

### BACKGROUND ART

As schemes for deduplication of data, two schemes of post-process (PSP) and inline process (ILP) are known. In the post-process scheme, because the deduplication of data is performed asynchronously with host I/O, influence on write performance is small. However, in the post-process scheme, because data is once stored in a disk and thereafter a data amount reduction is carried out, a disk capacity of a temporary area is necessary. On the other hand, in the inline process scheme, because the deduplication of data is carried out at a host I/O opportunity, unlike the post-process scheme, it is unnecessary to store data in a temporary area.

### CITATION LIST

### Patent Literature

PTL 1: International Publication No. WO 2014/069617

### SUMMARY OF INVENTION

### Technical Problem

In the inline process scheme, when an update write request is received for deduplicated data, processing for excluding the data from a target of deduplication is necessary. Because a load of this processing is large, throughput performance of the inline process scheme is lower than throughput performance of the post-process scheme.

### Solution to Problem

To solve the problem, a computer system according to an aspect of the present invention includes: a memory; and a processor connected to the memory. When a first logical area is not associated with a physical area in a data storage area and a first write request for requesting to write, in the first logical area, first data not stored in the data storage area is received, the processor is configured to calculate first identification information based on the first data, write the first data in a first physical area in the data storage area, register, in conversion information, association of an address of the first logical area, an address of the first physical area, and first present identification information indicating the first identification information, and register, in duplication information, association of the first identification information and the address of the first logical area. After the first write request, when a second logical area is not associated with a physical area in the data storage area and a second write request for requesting to write the first data in the second logical area is received, the processor is configured to calculate the first identification information based on the first data, register, in the conversion information, association of an address of the second logical area, the address of the first physical area, and second present identification information indicating the first identification information, and register, in the duplication information, association of the first identification information and the address of the second logical area. After the first write request, when a third write request for requesting to write, in the first logical area, second data not stored in the data storage area is received, the processor is configured to calculate second identification information based on the second data, write the second data in a second physical area in the data storage area, register, in the conversion information, association of the address of the first logical area, the address of the second physical area, the first present identification information indicating the second identification information, and first old identification information indicating the first identification information, and register, in the duplication information, association of the second identification information and the address of the first logical area. When the first logical area satisfies a preset separation condition, the processor is configured to delete the address of the first logical area from the duplication information and delete the first old identification information from information associated with the address of the first logical area in the conversion information.

### Advantageous Effect of Invention

The throughput performance of the inline process scheme is improved.

### BRIEF DESCRIPTION OF DRAWINGS

FIG. 1 shows the configuration of a computer system.

FIG. 2 shows a logical configuration of the computer system.

FIG. 3 shows a logical-physical conversion table 160.

FIG. 4 shows an FPT VOL 330.

FIG. 5 shows an inline process.

FIG. 6 shows garbage collection.

FIG. 7 shows FPT entry deletion processing.

### DESCRIPTION OF EMBODIMENT

An embodiment of the present invention is explained below with reference to the drawings.

In the following explanation, information is sometimes explained using representation “XXX table”. However, the information may be represented in any data structure. That is, the “XXX table” can be called “XXX information” to indicate that the information does not depend on the data structure. In the following explanation, configurations of tables are examples. One table may be divided into two or more tables. All or a part of two or more tables may be one table.

In the following explanation, an ID is used as identification information of an element. However, other kinds of identification information may be used instead of or in addition to the ID.

In the following explanation, when elements of the same type are explained without being distinguished, a reference sign or a common number in the reference sign is used. When the elements of the same type are distinguished and explained, reference signs of the elements are sometimes used or IDs allocated to the elements are sometimes used instead of the reference signs.

In the following explanation, an I/O (Input/Output) request is a write request or a read request and may be called access request.

In the following explanation, processing is sometimes explained using a “program” as a subject. However, the program is executed by a processor (e.g., a CPU (Central Processing Unit)) to perform decided processing while using, for example, a storage resource (e.g., a memory) and/or an interface device (e.g., a communication port) as appropriate. Therefore, the subject of the processing may be the processor. The processing explained using the program as the subject may be processing or a system performed by the processor or an apparatus including the processor. The processor may include a hardware circuit configured to perform a part or the entire processing. The program may be installed in an apparatus such as a computer from a program source. The program source may be, for example, a program distributing server or a computer-readable storage medium. When the program source is the program distribution server, the program distribution server may include a processor (e.g., a CPU) and a storage resource. The storage resource may further store a distribution program and a distribution target program. The processor of the program distribution sever may execute the distribution program to distribute the distribution target program to other computers. In the following explanation, two or more programs may be realized as one program. One program may be realized as two or more programs.

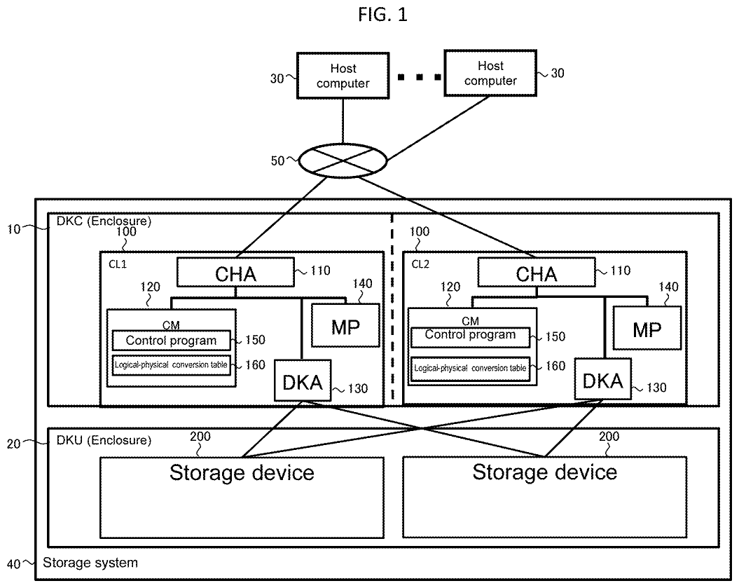

FIG. 1 shows the configuration of a computer system.

The computer system includes a host computer 30 and a storage system 40. The storage system 40 includes a disk controller (DKC) 10 and a disk unit (DKU) 20. The DKU 20 is connected to a disk controller 10 via an interface such as an SAS (Serial Attached Small Computer System Interface) or an SATA (Serial Advanced Technology Attachment). The disk controller 10 is connected to the host computer 30 via a network 50 such as a SAN.

The disk controller 10 includes two clusters 100 (CL1 and CL2). The two clusters 100 perform communication each other. Even if a failure occurs in one cluster, the other cluster operates. Therefore, the disk controller 10 can continue operation. The cluster 100 includes a channel adapter 110, a cache memory (CM) 120, a disk adapter (DKA) 130, and a microprocessor (MP) 140.

The channel adapter 110 is connected to the host computer 30 and controls communication with the host computer 30. The cache memory 120 stores computer programs such as a control program 150 and data such as a logical-physical conversion table 160. The disk adapter 130 is connected to the disk unit 20 and controls communication with the disk unit 20. The microprocessor 140 executes processing according to the computer programs stored in the cache memory 120.

The disk unit 20 includes a plurality of storage devices 200. The storage devices 200 are, for example, a SSD (solid state drive) and a HDD (hard disk drive) and are connected to disk adapters 130 of a plurality of clusters 100.

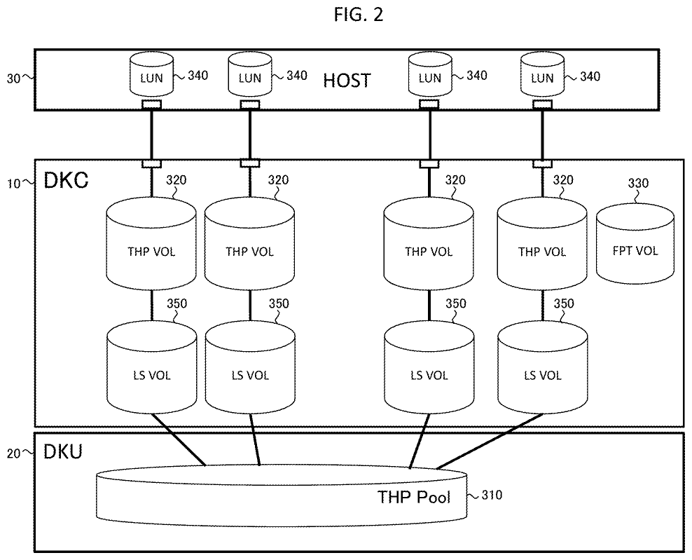

FIG. 2 shows a logical configuration of the computer system.

The disk controller 10 generates a THP (thin provisioning) pool 310 using the storage devices 200 in the disk unit 20. The disk controller 10 generates a log-structured (LS) volume 350, which is a volume that uses a log-structured (write-once) file system. The disk controller 10 allocates a storage area in the THP pool 310 to the log-structured volume 350. The disk controller 10 generates a THP VOL (volume) 320 and allocates a physical area in the log-structured volume 350 to the THP VOL 320. The physical area in the log-structured volume 350 may be a physical area in the cache memory 120 associated with the storage area in the THP pool 310. The disk controller 10 performs setting of deduplication on the THP VOL 320.

The THP VOL 320 includes a plurality of logical areas. The logical area may be called logical block. The logical area in the THP VOL 320 is indicated by a logical address (LA). The physical area in the log-structured volume 350 is indicated by a physical address (PA). The log-structured volume 350 includes a plurality of pages. The page includes a plurality of physical areas. The physical area may be called a physical block. A size of the logical area and the physical area is, for example, 8 kB. When data is stored in a physical area associated with a certain logical area and a write request for requesting to write update data in the logical area is received, the control program 150 writes the update data in a new physical area different from the physical area and associates the new physical area with the logical area. When data of a plurality of logical areas are duplicate, the control program 150 allocates the same physical area to the logical areas.

Further, the disk controller 10 generates an FPT (fingerprint table) VOL 330 for managing an FPK (fingerprint key). The FPK is a hash value of data. The host computer 30 generates a LUN 340 and allocates the THP VOL 320 to the LUN 340.

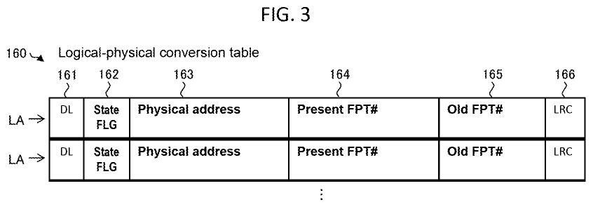

FIG. 3 shows the logical-physical conversion table 160.

The logical-physical conversion table 160 includes a logical-physical conversion entry for each of logical areas. To the logical-physical conversion entry of one logical area, a logical address of the logical area is given. The logical-physical conversion entry of one logical area includes, as fields, a data length (DL) 161, a state flag 162, a physical address (PA) 163, a present FPT number (#) 164, an old FPT number (#) 165, and a LRC (longitudinal redundancy check) 166. The logical-physical conversion entry has a preset size. The fields of the logical-physical entry have preset seizes.

The DL 161 is length of data stored in the THP pool 310. When data is compressed and stored, the DL 161 is length of the compressed data. The state flag 162 is a flag indicating a state of the logical-physical conversion entry. The physical address 163 is an address of a physical area associated with the logical area in the log-structured volume 350. The present FPT number 164 is an FPT number obtained from an FPK of the latest data in the logical area. The FPT number is a portion of a predetermined position in a bit string of the FPK and is used to retrieve the FPK from the FPT VOL 330. For example, length of the FPK is 8 Bytes. The present FPT number 164 is high-order 4 Bytes of the FPK. The old FPT number 165 is an FPT number obtained from pre-update data of the latest data of the logical area. For example, like the present FPT number 164, the old FPT number 165 may be the high-order 4 Bytes of the FPK or may have length shorter than the present FPT number 164 such as high-order 3 Bytes of the FPK. The LRC 166 is a check code calculated from the logical-physical conversion entry.

Even if the length of the old FPT number 165 and the length of the present FPT number 164 are different by approximately 1 Byte, a great performance difference does not occur between retrieval of the old FPT number 165 and retrieval of the present FPT number 164. Note that the present FPT number 164 and the old FPT number 165 may be the FPK.

With the logical-physical conversion table, the control program 150 can specify, from a logical address, a physical address corresponding to the logical address.

The control program 150 may further generate a physical-logical conversion table for specifying, from a physical address, a logical address corresponding to the physical address and store the physical-logical conversion table in the cache memory 120.

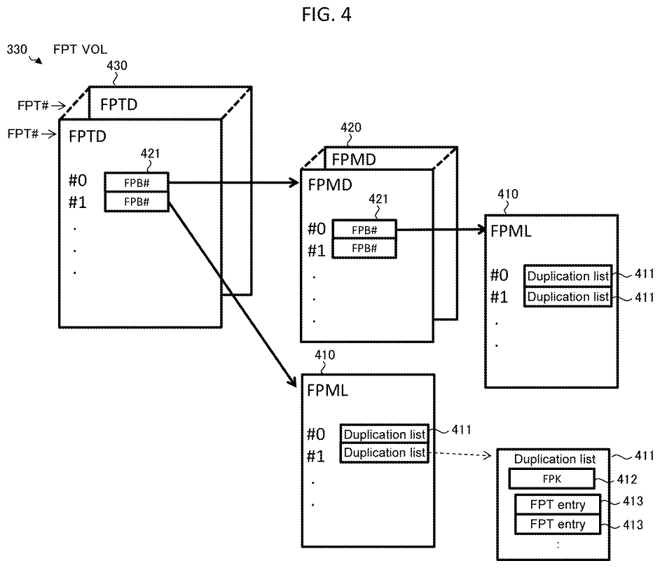

FIG. 4 shows the FPT VOL 330.

The FPT VOL 330 stores an FPML 410, an FPMD 420, and an FPTD (FPT directory) 430.

The FPML 410 is a block structure that can store several duplication lists 411. The duplication list 411 includes one FPK 412 and several FPT entries 413. The FPT entry 413 includes a logical address (LA). An FPB number is given to the FPML 410.

The FPMD 420 is a block structure indicating a directory for managing the FPML 410. The FPMD 420 stores an FPB number 421 indicating the FPML 410 in the directory. An FPB number is given to the FPMD 420 as well.

The FPTD 430 is a block structure indicating a directory for managing the FPML 410 and the FPMD 420. The FPTD 410 stores the FPB number 421 indicating the FPML 410 or the FPMD 420 in the directory. At least a part of a bit string of an FPT number belonging to the director is given to the FPTD 430.

Respective sizes of the FPML 410, the FPMD 420, and the FPTD 430 are equal to or smaller than a preset upper limit size. The upper limit size is, for example, 512 kB. When the size of the FPML 410 exceeds the upper limit size, a new FPML 410 is generated. The FPMLs 410 are managed by the directory of the FPMD 420.

The control program 150 can retrieve, using an FPT number included in an FPK, the FPK from the FPT VOL 330 and acquire an LA corresponding to the FPK. With the FPT VOL 330, the control program 150 can easily add an FPK to the FPT VOL 330.

When the capacity of the FPT VOL 330 is large, the entire FPT VOL 330 cannot be stored in the cache memory 120. Therefore, the control program 150 reads out a part of the FPT VOL 330 to the cache memory 120 and accesses the part of the FPT VOL 330. Because the FPK is a hash value, the access to the FPT VOL 330 is substantially a random access. Consequently, in retrieval of the FPT VOL 330, the storage devices 200 are often accessed. A processing time increases.

When the logical-physical conversion entry cannot store the old FPT number 165 and stores only the present FPT number 164, in order to release association of a present FPT number and a logical address in every update write, the present FPT number is retrieved from the FPT VOL 330. Consequently, a load on the storage system. 40 increases and throughput performance of the storage system 40 decreases. In the logical-physical conversion table 160 in this embodiment, because the logical-physical conversion entry stores the old FPT number 165, the inline process prevents the association of the present FPT number and the logical address from being released in every update write.

The operation of the control program 150 is explained below.

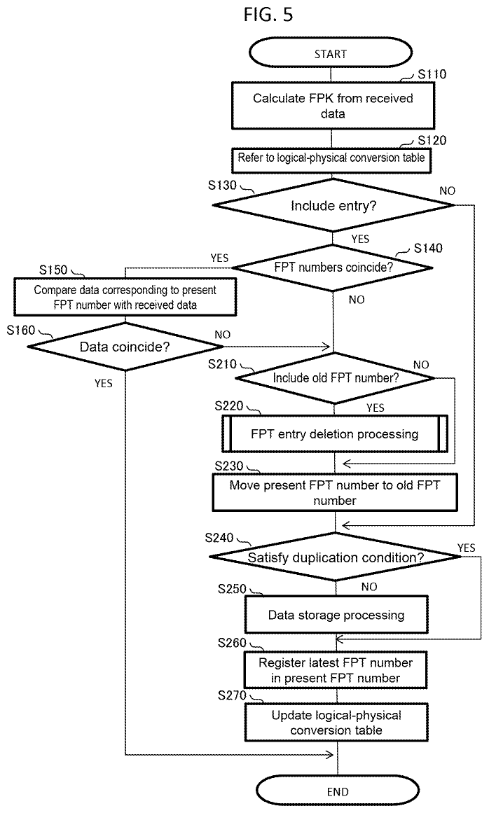

FIG. 5 shows the inline process.

In S110, when a write request and write data to a target logical address are received from the host computer 30, the control program 150 performs a hash operation of the write data at each preset length to calculate an FPK of the write data as a target FPK and calculate the portion of a predetermined position of a bit string of the target FPK as a target FPT number. Note that the control program 150 writes the write data in the cache memory 120 and then transmits a response to the host computer 30.

In S120, the control program 150 refers to the logical-physical conversion table 160.

In S130, the control program 150 determines whether the logical-physical conversion table 160 includes a target logical-physical conversion entry corresponding to the target logical address.

When, as a result of S130, determining that the logical-physical conversion table 160 includes the target logical-physical conversion entry (YES), in S140, the control program 150 determines whether the target FPT number coincides with the present FPT number 164 of the target logical-physical conversion entry.

When, as a result of S140, determining that the target FPT number coincides with the present FPT number (YES), in S150, the control program 150 compares the write data and stored data stored in the physical address 163 of the target logical-physical conversion entry. In S160, the control program 150 determines whether the write data coincides with the stored data as a result of the comparison.

When, as a result of S160, determining that the write data coincides with the stored data (YES), the control program 150 ends this flow. That is, in this case, it is unnecessary to update the data stored in the target logical address.

When, as a result of S160, determining that the write data does not coincide with the stored data (NO), in S210, the control program 150 determines whether the target logical-physical conversion entry includes a value of the old FPT number 165.

When, as a result of S210, determining that the target logical-physical conversion entry includes a value of the old FPT number 165 (YES), in S220, the control program 150 performs FPT entry deletion processing for releasing association of an old FPT number and a target logical address. The FPT entry deletion processing is explained below.

After S220 or when, as a result of S210, determining that the target logical-physical conversion entry does not include a value of the old FPT number 165 (NO), in S230, the control program 150 migrates a value of the present FPT number 164 to the old FPT number 165 in the target logical-physical conversion entry.

After S230 or when, as a result of S130, determining that the logical-physical conversion table 160 does not include the target logical-physical conversion entry (NO), in S240, the control program 150 determines whether the write data satisfies a duplication condition. When the FPT VOL 330 includes a duplication list corresponding to the target FPT number and the target data coincides with data stored in a physical address corresponding to a logical address in the duplication list, the control program 150 determines that the write data satisfies the duplication condition.

When, as a result of S240, determining that the write data does not satisfy the duplication condition (NO), in S250, the control program 150 stores the write data.

After S250 or when, as a result of S240, determining that the write data satisfies the duplication condition (YES), in S260, the control program 150 registers the target FPT number in the present FPT number 164 of the target entry. In S270, the control program 150 registers a write destination of the write data in the physical address 163 of the target logical-physical conversion entry and ends this flow.

With the inline process explained above, when the write request for updating the logical area of the target logical address is received and the target logical-physical conversion entry does not include a value of the old FPT number, the control program 150 migrates the FPT number of the pre-update data to the old FPT number. Therefore, it is unnecessary to immediately perform the FPT entry deletion processing. Consequently, the throughput performance of the storage system 40 can be improved.

The old FPT number can be deleted from the logical-physical conversion entry by garbage collection explained below. When a time interval of write to the same logical address is long, a probability that the old FPT number is deleted and the result of S210 is NO increases. Consequently, the number of times of execution of the FPT entry deletion processing can be reduced. Note that, when the write request for updating the logical area of the target logical address is received and the target logical-physical conversion entry includes a value of the old FPT number, the control program 150 immediately performs the FPT deletion processing.

When valid data is written in a free space of the log-structured volume 350 every time the THP VOL 320 is updated, free spaces of the log-structured volume 350 and the THP pool 310 decrease. The control program 150 performs garbage collection for migrating valid data in a page to another page to generate a free page. Consequently, the control program 150 can increase the free space of the log-structured volume 350.

When a free area of the storage system 40 satisfies a preset execution condition, the control program 150 performs the garbage collection asynchronously with a write request from the host computer 30. For example, when a use ratio, which is a ratio of a size allocated to the THP VOL 320 in the capacity of the THP pool 310, exceeds a preset use ratio threshold, the control program 150 determines that the free space of the storage system 40 satisfies the execution condition. For example, the control program 150 calculates, as an invalid ratio, a ratio of invalid data in the size allocated to the THP VOL 320 from the THP pool 310. When the invalid ratio exceeds a preset invalid ratio threshold, the control program 150 determines that the free space of the storage system 40 satisfies the execution condition.

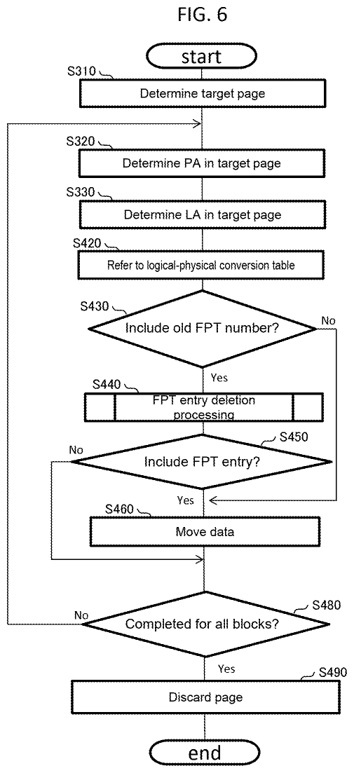

FIG. 6 shows the garbage collection.

In S310, the control program 150 selects a target page satisfying a migration condition out of a plurality of pages. The control program 150 may select, as the target page, a page in which an invalid data amount exceeds a preset threshold. The control program 150 may select, as the target page, pages in order from a page having a largest invalid data amount until the free space of the storage system 40 does not satisfy the execution condition. The invalid data amount is an invalid ratio or an invalid data size. The invalid ratio is a ratio of the invalid data size with respect to a size of a page.

In S320, the control program 150 selects, from the target page, one physical area as a target physical area in the order of physical addresses and selects a physical address of the target physical area as a target physical address. In S330, the control program 150 selects, on the basis of the physical-logical conversion table, as a target logical area, a logical area associated with the target physical area and selects a logical address of the target logical area as a target logical address.

In S420, the control program 150 refers to the logical-physical conversion table 160. In S430, the control program 150 determines whether a value of the old FPT number 165 is present in a target logical-physical conversion entry corresponding to the logical target address in the logical-physical conversion table 160.

When, as a result of S430, determining that a value of the old FPT number is present in the target logical-physical conversion entry (YES), in S440, the control program 150 performs FPT entry deletion processing for releasing the association of the old FPT number and the target logical address. In S450, the control program 150 determines whether a duplication list corresponding to the old FPT number includes at least one FPT entry.

When, as a result of S450, determining that the duplication list includes at least one FPT entry (YES) or when, as a result of S430, determining that a value of the old FPT number is absent (NO), because the target physical area is associated with the logical address and valid data is stored in the target physical area, in S460, the control program 150 selects a migration destination page and a migration destination physical area, which is a physical area in the migration destination page and migrates data in the target physical area to the migration destination physical area. Further, the control program 150 registers a physical address of the migration destination physical area in the physical address 163 in the logical area entry corresponding to the logical address in the logical-physical conversion table 160.

After S460 or when, as a result of S450, determining that the duplication list does not include an FPT entry (NO), because the target physical area does not store valid data, in S480, the control program 150 determines whether all physical areas in the target page have been selected as the target physical area.

When, as a result of S480, a physical area not selected as the target physical area is present in the target page (NO), the control program 150 shifts the processing to S320 and selects the next target physical area.

When, as a result of S480, all the physical areas in the target page have been selected as the target physical area (YES), in S490, the control program 150 discards the target page and ends this flow. Thereafter, according to a write request, the control program 150 writes data in the target page, which has become a free page.

With the garbage collection explained above, when the old FPT number is present in the logical-physical conversion entry of the target logical area of the garbage collection, the control program 150 can release the association with the data indicated by the old FPT number. Consequently, the control program 150 deletes the old FPT number in the logical-physical conversion entry. The control program 150 does not need to perform the FPT entry deletion processing during the next update of the logical area. Because the control program 150 performs the garbage collection asynchronously with the write request, a load during the write request can be reduced.

When the logical area of the target logical address satisfies a preset separation condition, the control program 150 performs the FPT entry deletion processing. The separation condition is, for example, a condition for shifting to S220 or S440 explained above.

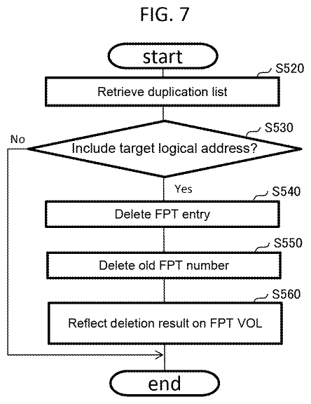

FIG. 7 shows the FPT entry deletion processing.

In S220 and S440 explained above, the control program 150 designates an old FPT number and a target logical address and performs the FPT entry deletion processing.

In S520, the control program 150 retrieves a duplication list corresponding to the old FPT number from the FPT VOL 330 and reads out the retrieved duplication list to the cache memory 120 as a target duplication list. In S530, the control program 150 determines whether the target duplication list includes a target logical address.

When, as a result of S530, determining that the target duplication list does not include the target logical address (NO), the control program 150 ends this flow.

When, as a result of S530, determining that the target duplication list includes the target logical address (YES), in S540, the control program 150 deletes an FPT entry including the target logical address from the target duplication list and shifts the FPT entry in the target duplication list forward. In S550, the control program 150 deletes a value of the old FPT number 165 from the logical-physical conversion entry of the target logical address in the logical-physical conversion table 160. In S560, the control program 150 reflects the updated target duplication list on the FPT VOL 330 and ends this flow. The control program 150 may asynchronously reflect the update of the FPT VOL 330 on the THP pool 310 from the cache memory 120.

According to the FPT entry deletion processing explained above, the control program 150 can release the association of the old FPT number and the target logical address.

Effects of this embodiment are explained below.

When a write request to a specific logical area is sequential write, an interval for updating the logical area is longer than when the write request to the logical area is random write. When the interval for updating the logical area is longer, a probability that the garbage collection is executed during the update and a value of the old FPT number is deleted by the FPT entry deletion processing during the garbage collection increases. Consequently, a probability that the FPT entry deletion processing is not executed during write increases. That is, even if a value is registered in the old FPT number by the update of the logical area, the value of the old FPT number is deleted before the next update. The FPT entry deletion processing is not executed during the next update. Consequently, the throughput performance of the storage system 40 can be improved.

As an example of the sequential write, there is backup. When the host computer 30 periodically writes, in the storage system 40, a backup of data stored in the host computer 30 at a predetermined backup cycle, a probability that the garbage collection is executed during the backup and a value of the old FPT number is deleted increases. For example, it is assumed that the host computer 30 writes a backup in a first THP VOL on Monday every week, writes a backup in a second THP VOL on Tuesday every week, writes a backup in a third THP VOL on Wednesday every week, writes a backup in a fourth THP VOL on Thursday every week, and writes a backup in a fifth THP VOL on Friday every week. In this case, the THP VOLs are updated once in a week. In this way, the backup is executed at a sufficiently long time interval. Consequently, a probability that the garbage collection is executed during the backup and a value of the old FPT number is deleted increases.

A computer such as a backup server may be used instead of the disk controller 10. In this case, the backup server is connected to the same external storage device as the disk unit 20. The backup server includes a storage device configured to store the same information as the FPT VOL 330 and executes the control program 150. Consequently, the backup server can perform deduplication of the external storage device.

The computer system corresponds to the storage system 40, the disk controller 10, the backup server, and the like. The memory corresponds to the cache memory 120 and the like. The processor corresponds to the MP 140 and the like. The data storage area corresponds to the log-structured volume 350, the THP pool 310, and the like. The duplication information corresponds to the FPT VOL 330 and the like. The identification information corresponds to the FPT number and the like. The conversion information corresponds to the logical-physical conversion table 160, the physical-logical conversion table, and the like. The present identification information corresponds to the value of the present FPT number 164 and the like. The old identification information corresponds to a value of the old FPT number 165 and the like. The present identification information area corresponds to the field of the present FPT number 164 and the like. The old identification information area corresponds to the field of the old FPT number 165 and the like. The fingerprint corresponds to the FPK and the like.

The embodiment of the present invention is explained above. This is illustration for the explanation of the present invention and is not meant to limit the scope of the present invention to the configuration explained above. The present invention can be carried out in other various forms.

### REFERENCE SINGS LIST

10 . . . disk controller, 20 . . . disk unit, 30 . . . host computer, 40 . . . storage system, 50 . . . network, 100 . . . cluster, 110 . . . channel adapter, 120 . . . cache memory, 130 . . . disk adapter, 140 . . . microprocessor, 150 . . . control program, 160 . . . logical-physical conversion table

1. A computer system comprising:
a memory; and
a processor connected to the memory, wherein
when a first logical area is not associated with a physical area in a data storage area and a first write request for requesting to write, in the first logical area, first data not stored in the data storage area is received, the processor is configured to calculate first identification information based on the first data, write the first data in a first physical area in the data storage area, register, in conversion information, association of an address of the first logical area, an address of the first physical area, and first present identification information indicating the first identification information, and register, in duplication information, association of the first identification information and the address of the first logical area,
after the first write request, when a second logical area is not associated with a physical area in the data storage area and a second write request for requesting to write the first data in the second logical area is received, the processor is configured to calculate the first identification information based on the first data, register, in the conversion information, association of an address of the second logical area, the address of the first physical area, and second present identification information indicating the first identification information, and register, in the duplication information, association of the first identification information and the address of the second logical area,
after the first write request, when a third write request for requesting to write, in the first logical area, second data not stored in the data storage area is received, the processor is configured to calculate second identification information based on the second data, write the second data in a second physical area in the data storage area, register, in the conversion information, association of the address of the first logical area, the address of the second physical area, the first present identification information indicating the second identification information, and first old identification information indicating the first identification information, and register, in the duplication information, association of the second identification information and the address of the first logical area, and
when the first logical area satisfies a preset separation condition, the processor is configured to delete the address of the first logical area from the duplication information and delete the first old identification information from information associated with the address of the first logical area in the conversion information.

2. The computer system according to claim 1, wherein, after the third write request, when the second physical area satisfies a preset migration condition and the conversion information includes association of the address of the first logical area, the address of the second physical area, and the first old identification information, the processor is configured to determine that the first logical area satisfies the separation condition and, when the duplication information does not include association of the first identification information and other logical areas, the processor is configured to select a migration destination physical area from the data storage area, migrate data stored in the second physical area to the migration destination physical area, and register, in the conversion information, information indicating that the migration destination physical area is associated with the first logical area instead of the second physical area.

3. The computer system according to claim 2, wherein, when the conversion information includes association of the address of the first logical area and the first old identification information and a write request for writing, in the first logical area, data not stored in the data storage area is received, the processor is configured to determine that the first logical area satisfies the separation condition.

4. The computer system according to claim 3, wherein, when a specific write request for requesting to write specific data in a specific logical area is received, the processor is configured to calculate a specific fingerprint, which is a hash value of the specific data, calculate, as identification information of the specific data, a portion of a predetermined position in a bit string of the specific fingerprint, and register, in the duplication information, association of the specific fingerprint and the specific logical area.

5. The computer system according to claim 4, wherein, when the specific write request is received, the processor is configured to determine whether the duplication information includes association of the specific fingerprint and a logical area and, when determining that the duplication information includes the association of the specific fingerprint and the logical area, specify the logical area associated with the specific finger print on the basis of the duplication information, specify a physical area associated with the specified logical area on the basis of the conversion information, and determine whether the specific data coincides with data stored in the specified physical area.

6. The computer system according to claim 5, further comprising a storage device configured to store the duplication information.

7. The computer system according to claim 6, wherein the storage device includes the data storage area.

8. The computer system according to claim 6, wherein the processor is configured to be connected to an external storage device including the data storage area.

9. The computer system according to claim 2, wherein
the data storage area includes a plurality of pages,
each of the pages includes a predetermined number of physical areas,
the processor is configured to manage the data storage area using a log-structured file system and determine whether a free space of the data storage area satisfies a preset execution condition, and
when determining that the free space of the data storage area satisfies the execution condition, the processor is configured to select, on the basis of an invalid data amount in the pages, a page that satisfies the migration condition.

10. The computer system according to claim 1, wherein
the conversion information includes an entry of a predetermined size associated with an address of a logical area, and
the entry includes a physical address area that stores an address of a physical area associated with the logical area, a present identification information area that stores identification information based on latest data of the logical area, and an old identification information area that stores identification information based on pre-update data of latest data of the logical area.

11. A data storage method comprising:
when a first logical area is not associated with a physical area in a data storage area and a first write request for requesting to write, in the first logical area, first data not stored in the data storage area is received, calculating first identification information based on the first data, writing the first data in a first physical area in the data storage area, registering, in conversion information, association of an address of the first logical area, an address of the first physical area, and first present identification information indicating the first identification information, and registering, in duplication information, association of the first identification information and the address of the first logical area,
after the first write request, when a second logical area is not associated with a physical area in the data storage area and a second write request for requesting to write the first data in the second logical area is received, calculating the first identification information based on the first data, registering, in the conversion information, association of an address of the second logical area, the address of the first physical area, and second present identification information indicating the first identification information, and registering, in the duplication information, association of the first identification information and the address of the second logical area,
after the first write request, when a third write request for requesting to write, in the first logical area, second data not stored in the data storage area is received, calculating second identification information based on the second data, writing the second data in a second physical area in the data storage area, registering, in the conversion information, association of the address of the first logical area, the address of the second physical area, the first present identification information indicating the second identification information, and first old identification information indicating the first identification information, and registering, in the duplication information, association of the second identification information and the address of the first logical area, and
when the first logical area satisfies a preset separation condition, deleting the address of the first logical area from the duplication information and deleting the first old identification information from information associated with the address of the first logical area in the conversion information.
